(19) United States
(12) Patent Application Publication
(10) Pub. No.: US 2006/0033627 A1
(43) Pub. Date: Feb. 16, 2006

(54) Pool net safety system

(75) Inventor: Blair Robert Esson, Houston, TX (US)

Correspondence Address: WILLIAM B. PATTERSON;MOSER, PATTERSON & SHERIDAN, L.L.P., Suite 1500, 3040 Post Oak Blvd., Houston, TX, 77056, US

(73) Assignee: Katchakid Inc.

(21) Appl. No.: 10/915,969

(22) Filed: Aug. 11, 2004

(51) Int. Cl. G08B 23/00; G08B 13/00

(52) U.S. Cl. 340/573.6; 340/565

(57) ABSTRACT

In general, the present invention relates to a method and an apparatus for detecting movement of a pool net. In one aspect, a pool net safety system for use with a pool is provided. The system includes a net attachable to a perimeter of the pool and at least one sensor assembly attached to the net. The at least one sensor assembly is capable of detecting movement of the net and transmitting a signal based upon the movement. The system further includes at least one receiver to receive the signal from the sensor assembly and broadcast a signal. In another aspect, a method of detecting an object on a pool net is provided. In yet another aspect, an apparatus for use with a pool is provided.

### BACKGROUND OF THE INVENTION

1. Field of the Invention

The present invention relates to a pool net safety system. More specifically, the invention relates to a pool net with a sensor to detect movement of the net. More particularly still, the invention relates to a pool net with a vibration sensor attached thereto and a transmitter for transmitting a signal from the sensor to a receiver to produce an audible warning.

2. Description of the Related Art

Pool nets are well known and are effective devices for making a pool safe when not in use. Typically, the nets are sized for each pool and are installed by anchoring the net around the perimeter of the pool and then tightening the net to a tension that would prevent a child or other object from reaching the water if they contact the net. In a typical example, shown in FIG. 1, a net is made of polyethylene braid formed into a mesh leaving openings 11 that are small enough to keep the head of an infant or a small child from fitting through the net, but large enough to discourage the infant child from trying to walk across the net 10.

Anchoring the perimeter of the net 10 to an area around a pool 15 is performed with fasteners 20 spaced out about 30 inches apart. The fasteners 20 are mated with anchors which are permanently located along the edge of the pool 15.

Once the net 10 is anchored around the perimeter of the pool 15, it is tightened using a central tightening system 25. As shown in FIG. 1, the tightening system 25 typically includes a series of pulleys 30 arranged near the center of the net 10 in a substantially circular fashion. The circular shape formed between the pulleys 30 can be enlarged or reduced in size to control the tensioning of the net 10. By using a ratcheting means 27, the net 10 can be tightened to a point where a child or other object of similar weight will be suspended on the surface of the net 10 above the water.

In addition to nets, there are alarms available for use with pools. These devices are typically installed below the water's surface and operate by sensing concussion in the water that is created if a body or other relatively large mass falls into the pool. An example of this type pool alarm is disclosed in U.S. Pat. No. 5,162,777, which is incorporated herein by reference in its entirety. The alarm device disclosed in the '777 patent includes a switch element and wave detector for monitoring the water pressure, as well as an acoustic alarm for broadcasting an signal upon detection of a difference in the water pressure. Another type of safety alarm is disclosed in U.S. Pat. No. 5,790,024, which is also incorporated herein by reference in its entirety. The safety alarm disclosed in the '024 patent includes a transmitter with an infra-red sensor, whereby the transmitter sends a signal to a receiver upon detection of a moving object.

While the alarms can be effective, their design means they do not activate until a child is already in the water. Because physical and mental damage or death can result in a matter of minutes, pool alarms may sound too late in some circumstances.

There is a need therefore, for a pool safety net with an alarm system that works in unison with the net to sense a child's contact with the net and to provide an alarm.

### SUMMARY OF THE INVENTION

In general, the present invention relates to a method and an apparatus for detecting movement of a pool net. In one aspect, a pool net safety system for use with a pool is provided. The system includes a net attachable to a perimeter of the pool and at least one sensor assembly attached to the net. The at least one sensor assembly is capable of detecting movement of the net and transmitting a signal based upon the movement. The system further includes at least one receiver to receive the signal from the sensor assembly and broadcast a signal.

In another aspect, a method of detecting an object on a pool net is provided. The method includes placing the pool net on a pool, wherein the pool net includes at least one sensor attached thereto. Next, a movement of the net is detected due to the object contacting the pool net. Thereafter, a signal is sent to a receiver, and then an audible warning is communicated.

In yet another aspect, an apparatus for use with a pool is provided. The apparatus includes a net attachable to the pool, the net having at least one sensor attached thereto. The at least one sensor is employed to detect movement in the net and then transmit a signal. The apparatus also includes a central tensioning system for applying a tension to the net. The apparatus further includes at least one receiver remotely located from the at least one sensor. The at least one receiver is used to receive the signal and then to broadcast an audible signal.

In yet another aspect, a safety system for use with a pool is provided. The safety system includes a cover attachable to the perimeter of the pool. The safety system also includes at least one sensor assembly for detecting movement of the cover and transmitting a signal based upon the movement. The at least one sensor is operatively attached to the cover. The safety system further includes at least one receiver to receive the signal from the sensor assembly and broadcast a warning.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top view of a pool net attached to a pool.

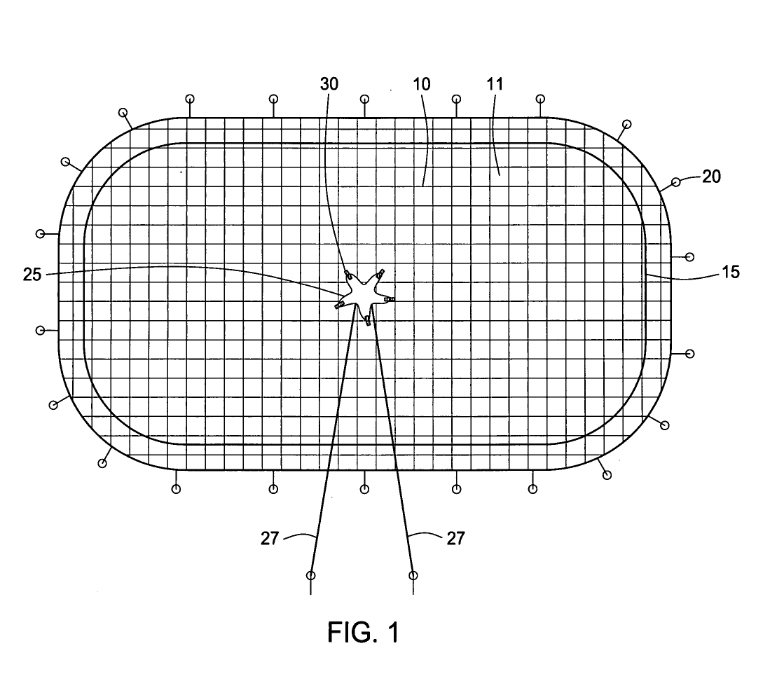

FIG. 2 is a top view illustrating a pool net safety system in accordance with the present invention.

FIG. 3 is a top view illustrating the pool net safety system after a sensor has been actuated.

### DETAILED DESCRIPTION

The present invention relates to a pool net safety system. As will be described herein, the safety system includes a sensor assembly for sensing movement of the net and a receiver for broadcasting an audible warning upon reception of a signal from the sensor assembly. It should be noted that the net safety system of the present invention is not limited to swimming pools. Rather, the net safety system is equally applicable to water reservoirs, ponds, or any other liquid containers usable with a safety net. It should be further noted that the safety system may be used in conjunction with a surrounding pool fence. To better understand the novelty of the apparatus of the present invention and the methods of use thereof, reference is hereafter made to the accompanying drawings.

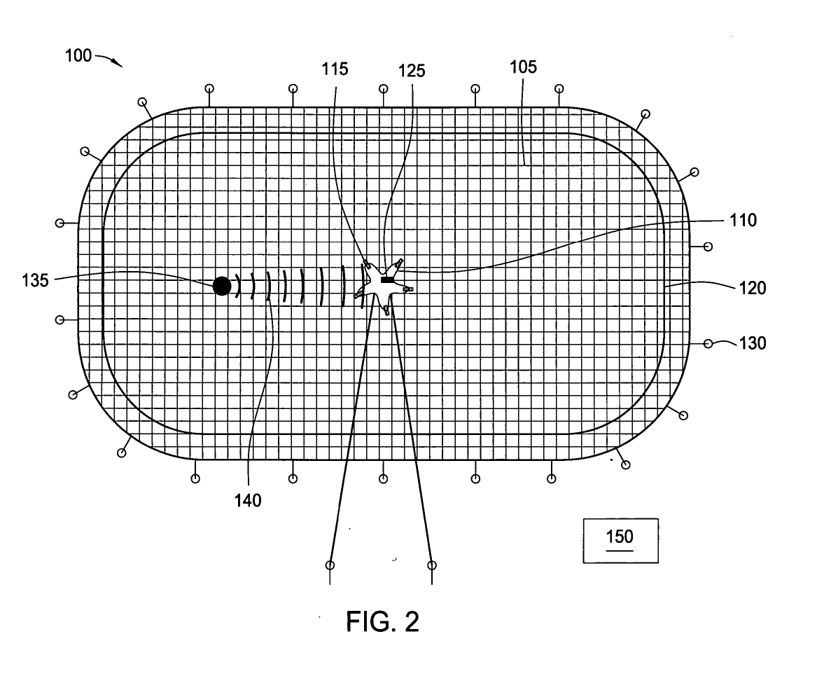

FIG. 2 is a top view a pool net safety system 100 in accordance with an embodiment of the present invention. The system 100 includes a net 105 constructed from a high density polyethylene braid or a similar material capable of being held in tension. Proximate the middle of the net 105 is a central tensioning system 110 that includes a plurality of pulleys 115 arranged in a substantially circular fashion. The central tensioning system 110 is employed to control the tension applied to the net 105. In operation, after the net 105 is attached around the perimeter of a pool 120 by a plurality of anchor members 130, the central tensioning system 110 is employed to add a predetermined tension to the net 105.

The safety system 100 further includes a sensor 125 for detecting contact between an object 135, like a child and the net 105. The sensor 125 includes circuitry for detecting movement 140 in the net 105 generated by the object 135 contacting the net 105. In other words, as the object 135 contacts any part of the net 105, the net because its material is in tension vibrates and the vibration 140 is translated through the braids of the net 105 to the sensor 125. The sensor 125 receives the vibrational signal and then operates to transmit a signal through a transmitter (not shown) to a receiver 150 as will be discussed herein.

The sensor 125 can be any type of water resistant sensor capable of detecting movement, like vibration, such as a sensor having a mercury switch. Generally, mercury switches consist of a mercury filled tube with electrodes at each end. When the tube is tilted, the mercury flows to either end cutting off the circuit on one end while opening it on the other side. For instance, the mercury switch could be an open circuit when it is at rest, but becomes a short circuit when it is moved.

The sensor 125 may also be a vibration sensor. Generally, vibration sensors are sensors for measuring, displaying, and analyzing linear velocity, displacement, and proximity, or else acceleration. They can be used on a stand-alone basis, or in conjunction with a data acquisition system. Vibration sensors are available in many forms. They can be raw sensing elements, packaged transducers, or as a sensor system or instrument incorporating features such as totalizing, local or remote display, and data recording. These devices work on many operating principles. The most common types of vibration sensors are piezoelectric, capacitance, null-balance, strain gage, resonance beam, piezoresistive, and magnetic induction. An alternative to traditional vibration sensors is one manufactured using MEMS technology, a micro-machining technology that allows for a much smaller device and thus package design.

As illustrated in FIG. 2, the sensor 125 is operatively connected to the net 105 proximate the central tensioning system 110 so that its sensitivity to movement at any place on the net is maximized. It should be understood, however, that any number of sensors may be employed at various places on the pool net, without departing from principles of the invention. The sensor 125 may be connected to the net 105 by various connection means, such as a clip member. Typically, the sensor 125 is powered by an internal power supply, such as a battery. Alternatively, the sensor may be powered by an external power source connected to the sensor 125 via a cable (not shown).

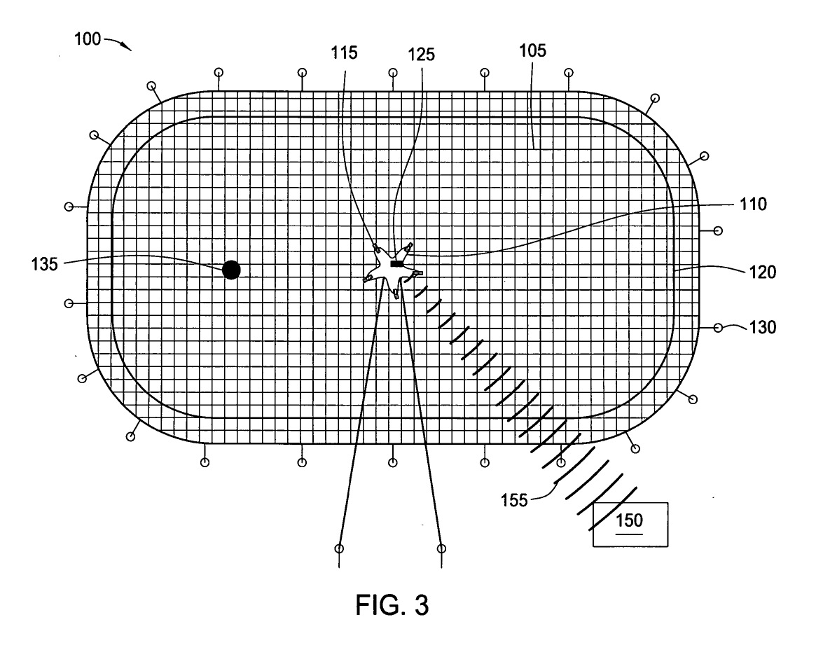

FIG. 3 is a view illustrating the pool net safety system 100 after the sensor 125 has been actuated. The sensor 125 is constructed with an internal transmitter (not shown) to transmit a signal 155 to the remote receiver 150. The signal 155 may be transmitted in a wireless manner, whereby the sensor 125 broadcasts the signal 155 through the air to the receiver 150, as shown in FIG. 3.

In another embodiment, an external transmitter (not shown) may be employed between the sensor 125 and the receiver 150. Generally, the transmitter is a device that sends a signal to the receiver 150 after the sensor 125 has been actuated. Typically, the transmitter is connected to the sensor 125 via a wire (not shown), such as marine wire. The wire may be embedded in the braids of the net 105 or as a separate wire operatively attached to the net 105. In either case, the sensor 125 sends the signal through the wire to the transmitter and then the transmitter sends the signal to the receiver 150 in a wireless format or through another wire (not shown). Typically, the transmitter houses the power supply for the sensor 125.

Upon signal reception from either the sensor 125 or the transmitter, the receiver 150 broadcasts an audible signal, such as a voice message, to indicate the object 135 has contacted the net 105. The receiver 150 may be configured to broadcast different audible signals based upon the signal reception from either the sensor 125 or the transmitter.

In operation, a net is attached around the perimeter of a pool by a plurality of anchor members. The net includes a central tensioning system and a pool net safety system. Thereafter, the central tensioning system is employed to add a predetermined tension to the net. While the pool is covered by the net, any foreign object contacting the net causes the net to vibrate and subsequently the vibration is translated through the braids of the net to a sensor in the pool net safety system. Upon reception of the vibration, the sensor transmits a signal to a transmitter or directly to a receiver. In turn, the receiver broadcasts a signal, such as audible and/or visual signal, to indicate the object has contacted the net.

Although the pool safety system has been described in relation to a pool net, the principles of the present invention are equally applicable to a mesh pool cover or a solid pool cover. For example, a cover having a pool safety system could be attached to the perimeter of a pool and the cover could be tensioned by a means well known in the art. Thereafter, any foreign object that contacts the cover could cause the cover to vibrate and the vibration could be translated through the cover to a sensor in the pool safety system. Upon reception of the vibration, the sensor could transmit a signal to a transmitter or directly to a receiver in a similar manner as described above. In turn, the receiver could broadcast an audible warning, such as a voice message, to indicate the object has contacted the cover.

While the foregoing is directed to embodiments of the present invention, other and further embodiments of the invention may be devised without departing from the basic scope thereof, and the scope thereof is determined by the claims that follow.

1. A pool net safety system for use with a pool, comprising:
a net attachable to a perimeter of the pool;
at least one sensor assembly attached to the net, the at least one sensor assembly capable of detecting movement of the net and transmitting a signal based upon the movement; and
at least one receiver to receive the signal from the sensor assembly and broadcast a warning signal.

2. The system of claim 1, wherein the at least one sensor assembly includes an internal transmitter and power supply.

3. The system of claim 1, further including a transmitter in communication with the at least one sensor assembly.

4. The system of claim 3, wherein the transmitter is connected to the at least one sensor assembly via a wire.

5. The system of claim 4, wherein the wire is operatively attachable to a surface of the net.

6. The system of claim 4, wherein the net is made of braids formed into a mesh and the wire is embedded in the braids.

7. The system of claim 1, wherein the warning signal is an audible signal.

8. The system of claim 1, wherein the at least one sensor assembly includes a mercury switch.

9. The system of claim 1, wherein the at least one sensor assembly includes a vibration sensor.

10. The system of claim 1, further including a central tensioning system for applying a tension to the net.

11. The system of claim 1, wherein the warning signal is a visible signal.

12. The system of claim 1, wherein the at least one sensor assembly is attached to the net via a clip member.

13. A method of detecting an object on a pool net, comprising:
placing the pool net on a pool, the pool net having at least one sensor assembly attached thereto;
detecting a movement of the net due to the object contacting the pool net;
sending a signal from the at least one sensor assembly to a receiver; and
broadcasting a warning signal.

14. The method of claim 13, further including tensioning the pool net to a predetermined tension.

15. The method of claim 13, further including transmitting a signal from the at least one sensor assembly to a transmitter.

16. The method of claim 15, wherein the transmitter is connected to the at least one sensor assembly via a wire.

17. The method of claim 16, further including attaching the wire to a surface of the net.

18. An apparatus for use with a pool, comprising:
a net attachable to the pool, the net having at least one sensor assembly attached thereto, wherein the at least one sensor assembly is employed to detect movement in the net and then transmit a signal;
a central tensioning system for applying a tension to the net; and
at least one receiver remotely located from the at least one sensor assembly, the at least one receiver is used to receive the signal and then broadcast a warning signal.

19. A safety system for use with a pool, comprising:
a cover attachable to a perimeter of the pool;
at least one sensor assembly for detecting movement of the cover and transmitting a signal based upon the movement, wherein the at least one sensor is operatively attached to the cover; and
at least one receiver to receive the signal from the sensor assembly and broadcast a warning signal.
